(19) United States
(12) Patent Application Publication
(10) Pub. No.: US 2024/0395232 A1
(43) Pub. Date: Nov. 28, 2024

(54) SYSTEM AND METHOD FOR GUITAR COMPARISON

(71) Applicant: U.S. BAND & ORCHESTRA SUPPLIES, INC., St. Louis, MO (US)

(72) Inventors: Andrei Stefan HOLZER, London (GB); Christopher MEIKLE, Durham (GB)

(21) Appl. No.: 18/671,157

(22) Filed: May 22, 2024

Related U.S. Application Data
(60) Provisional application No. 63/503,568, filed on May 22, 2023.

(51) Int. Cl. G10H 1/00

(52) U.S. Cl. CPC G10H 1/0008; G10H 2240/131; G10H 2240/325

(57) ABSTRACT

The present technology relates to a method for content delivery, wherein the method includes receiving a first user input from a user equipment (UE) and in response to this input querying a database for digital content comprising a set of multimedia streams. The set of multimedia streams are associated with different types of musical instruments such as guitars, pianos, drums, and other stringed instruments. The method further includes identifying a plurality of parameters associated with each of the multimedia streams; generating a synchronized correlation of the plurality of parameters of each of the multimedia streams, wherein each of the multimedia streams are correlated with a same time code; and transmitting the multimedia streams and the synchronized correlation to a display of a UE, wherein the display is configured to permit the user to interact with the plurality of content in accordance with the same time code.

### CROSS-REFERENCE TO RELATED APPLICATIONS

This application claims the benefit of priority from the U.S. Provisional Patent Application No. 63/503,568, filed May 22, 2023, which is incorporated herein by reference in its entirety.

### FIELD OF TECHNOLOGY

The subject matter of this disclosure generally relates to the field of content delivery via a computer system and, more particularly, to instrument comparison based on an instrument type and instrumental type.

### BACKGROUND

Consumers in the market for an instrument often engage in a lengthy process prior to making a purchase to ensure that the instrument meets various personalized and customized specifications. When purchasing a guitar, consumers often will look at things like the body shape, size, weight, materials used in construction, neck shape, action level, and pickups. They also may consider the guitar's sound quality and whether it fits their playing style. Oftentimes, guitar comparisons take place online, creating a variety of difficulties of comparing guitars online without playing them, negating the experience of getting a true sense of how the instrument feels or sounds by determining things like the weight and size, as well as how its responds to your playing style without physically holding the instrument. With so many models and features, it can become overwhelming to find a guitar that meets various specifications without actually playing them and understanding their nuances better.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific examples, which are illustrated in the appended drawings. Understanding that these drawings depict only exemplary examples of the disclosure and are not therefore to be considered to be limiting of its scope, the principles herein are described and explained with additional specificity and detail through the use of the accompanying drawings in which:

FIG. 1 illustrates an example communication diagram of a content delivery network (CDN) for instrument comparison in accordance with some embodiments of the disclosure.

FIG. 2 illustrates an example process for guitar comparison in accordance with some embodiments of the disclosure.

FIG. 3A illustrates a selection module in a user interface of a user equipment (UE) in accordance with some embodiments of the disclosure.

FIG. 3B illustrates a first iteration of a guitar comparison in the selection module in the user interface of the UE in accordance with some embodiments of the disclosure.

FIG. 3C illustrates a second iteration of a guitar comparison in the selection module in the user interface of the UE in accordance with some embodiments of the disclosure.

FIG. 4 illustrates an example process of comparing a plurality of guitars in the comparison module in accordance with some embodiments of the disclosure.

FIG. 5 illustrates a routine 500 for comparing digital content of a plurality of guitar selections in accordance with some embodiments of the disclosure.

FIG. 6 illustrates an example computer system for executing a client application in accordance with some embodiments of the disclosure.

FIG. 7 shows an example of computing system, which can be for example any computing device that can implement components of the system in accordance with some embodiments of the disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification, including examples of any terms discussed herein, is illustrative only and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles can be used in the examples for the convenience of a reader, which in no way should limit the scope of the disclosure. Unless otherwise defined, technical and scientific terms herein have the meaning commonly understood by one of ordinary skill in the art to which this disclosure pertains. In the case of conflict, the present document, including definitions will control.

Additional features and advantages of the disclosure will be set forth in the description that follows and, in part, will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

The disclosure describes a guitar comparison tool that allows users to compare multiple guitar products in the same software. The guitar comparison tool works in both a browser and an application, such as a software application for a computing device or mobile device. The guitar comparison tool features three different playing styles-fingerstyle, open chord, and strumming-which can be compared in real-time by switching between pre-recorded videos. The tool queries a database and requests content from a Content Delivery Network (CDN), which is then delivered by the server. Finally, the videos are stitched together so that switching between instruments maintains synchronization, allowing users to make informed decisions about their purchase.

In one aspect, the present disclosure is directed towards a method for providing digital content. The method includes receiving a first user input from a user equipment (UE). The first user input can include a request to retrieve digital content comprising a set of multimedia streams. In response to receiving the first user input, a database can be queried for a plurality of content items associated with the set of multimedia streams. The method can include identifying a plurality of parameters associated with each multimedia stream. The method can include generating a synchronized correlation of the plurality of parameters of each multimedia stream. Each of the multimedia streams can be correlated with a same time code. The multimedia streams and the synchronized correlation can be transmitted to a display of a UE, wherein the display is configured to permit the user to interact with the plurality of content in accordance with the same time code.

In another aspect, the method further includes continuously updating the time code for each of the multimedia streams based on a playing position of at least one of the multimedia streams.

In another aspect, each of the multimedia streams comprises of audio and video.

In another aspect, the method further includes receiving from the database at least three sound types for each multimedia stream; and identifying additional time codes for each of the sound types based on the synchronized correlation.

In another aspect, the display of the UE is configured to permit the user to dynamic ally switch between each of the multimedia streams associated with at least one sound type, and the time code is maintained based on a playing position of at least one of the multimedia streams.

In another aspect, the method further includes interacting with at least one of the multimedia streams, wherein the interacting causes an update of the time code; and synchronously updating the time code for each additional multimedia stream in the set of multimedia streams based on the update of the time code.

In another aspect, the user input includes selecting at least three instrument types, wherein each instrument type is configured to be compared within the display of the UE; or selecting at least three playing styles, wherein each playing style is configured to be compared within the display of the UE.

In another aspect, the method further includes receiving a second user input from the user equipment comprising a second request, wherein the second request to retrieve digital content including an update to at least one of the multimedia streams; in response to receiving the second user input, querying the database for a plurality of content items associated with the update; and receiving a response from the database including an updated set of multimedia streams.

In another aspect, the method further includes generating a second synchronized correlation in accordance with the plurality of parameters, wherein each of the multimedia streams in the second set of multimedia streams are correlated with the same time code; and transmitting the updated set of multimedia streams and the synchronized correlation to the display of the UE.

In another aspect, the plurality of parameters includes a length of the multimedia streams, a multimedia type, and a size of the multimedia streams.

In one aspect, a system for providing digital content is provided. The system includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.). The one or more processors can cause the system to: receive a first user input from a user equipment (UE), the first user input comprising a request to retrieve digital content comprising a set of multimedia streams; in response to receiving the first user input, query a database for a plurality of content items associated with the set of multimedia streams; identify a plurality of parameters associated with each of the multimedia streams; generate a synchronized correlation of the plurality of parameters of each of the multimedia streams, wherein each of the multimedia streams are correlated with a same time code; and transmit the multimedia streams and the synchronized correlation to a display of a UE, wherein the display is configured to permit the user to interact with the plurality of content in accordance with the same time code.

In one aspect, a method for comparing digital content of a plurality of guitar selections is disclosed, The method includes receiving a first user input from a user equipment (UE), the first user input includes a request to retrieve digital content includes a set of multimedia streams associated with the plurality of guitar selections, where the first user input includes a first guitar selection includes a first guitar series and a first guitar model, a second guitar selection includes a second guitar series and a second guitar model, and a third guitar selection includes a third guitar series and a third guitar model. The method also includes transmitting a request including the first user input to a content delivery system, where the content delivery system is configured to query a database for a plurality of content items including the set of multimedia streams of the first, second, and third guitar selections. The method also includes identifying a plurality of parameters associated with each of the multimedia streams. The method also includes generating a synchronized correlation of the plurality of parameters of each of the multimedia streams, where each of the multimedia streams are correlated with a same time code. The method also includes transmitting the multimedia streams and the synchronized correlation to a display of a UE, where the display is configured to permit the user to interact with the plurality of content in accordance with the same time code.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The current market for purchasing instruments is very time-consuming and product limited. Consumers must often visit multiple retail stores in order to compare different features, sounds, and styles of guitars or other musical instruments. As a result, this can take up an immense amount of time as well as limit the types of products that consumers are able to compare and purchase. Consumers also may miss opportunities to get a better understanding of how the instrument feels or sounds determine things like the weight and size, as well as how it responds to their playing style without physically holding the instrument.

Customers in search of a guitar or instrument that possesses the sound, quality, and instrumentation that they are looking for often spend hours in multiple instrument/sound shops. These shopping hours often are spent on purchasing the exact instrument that is relevant to their performance needs, which includes picking up and playing multiple instruments to determine suitability. As such, there is a need for a more efficient shopping tool that allows a musician or music enthusiasts to easily compare different types of instruments in one platform without having to deal with the time and product limitation constraints of visiting multiple retail stores.

The technology described herein makes this process more efficient by providing a method for content delivery of multimedia streams associated with different types of products in one platform. This content delivery method allows for easy comparison of guitars or other instruments, enabling users to quickly and efficiently find the instrument that best suits their performance needs. The invention provides a synchronized correlation of the plurality of parameters associated with each product, allowing users to interact with the content in accordance with a synchronized playing experience.

Thus, the disclosed technology addresses the need for a web-based system for comparing multiple instrument types simultaneously based on at least one or more playing styles and instrumentation styles. As described below, the disclosed technology, through an example of comparing multiple guitar types, allows a consumer to choose up to three instruments and compare their tone and sound in real time by instantly changing between pre-recorded videos and three different playing styles.

The user can make their comparison selection, which prompts the tool to develop a query that queries the database. The server then pings a content delivery network (CDN), resulting in the CDN requesting the content from the database subsequently delivered by the server. After the query is sent and the files are received, the server can correlate the content for the different files together for a plurality of different types of playing, including but not limited to fingerstyle, open chord, and strumming

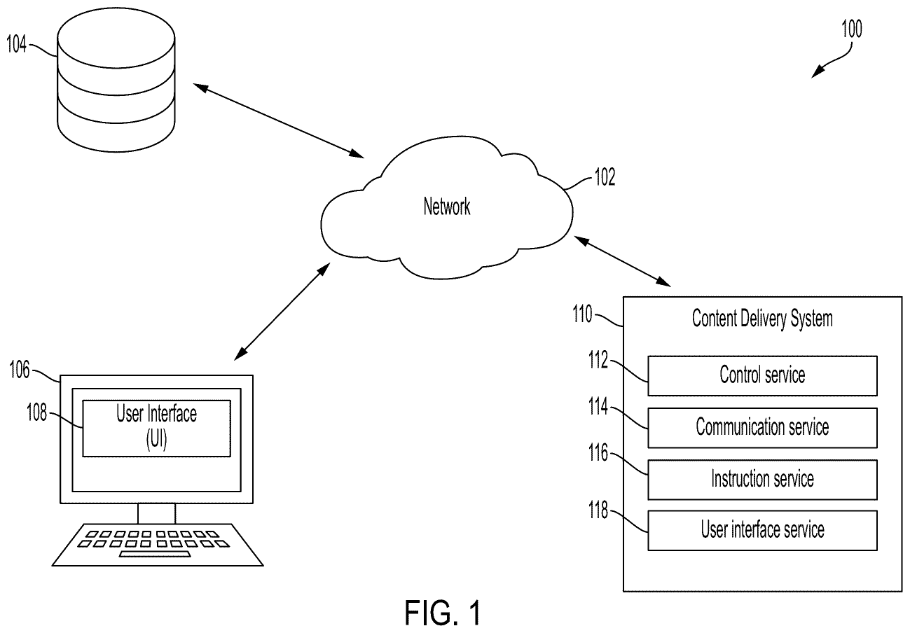

Prior to describing the proposed techniques and methods, an example communication environment for the delivery of the digital content related to the guitar comparison via user equipment of a user, as illustrated in FIG. 1, is described first.

FIG. 1 illustrates an example communication diagram of a CDN 100 for instrument comparison, according to aspects of the disclosure. The CDN 100 is configured to manage the retrieval, and transmission of content requested by a UE associated with the CDN 100. The CDN 100 can include a central network 102 that is configured to maintain the communication between one or more systems of the CDN 100 including a database 104, a user equipment (UE) 106, a user interface 108 of the UE 106, and a content delivery system 110.

The user interface 108 of the UE 106 of the CDN 100 includes a user interface 108 that is configured to receive a plurality of inputs from a user of the UE 106. For example, the user interface 108 can be configured to track a plurality of interactions by the user with the user interface 108, in order to identify requests that are made through the user interface 108 that require the acquisition of digital content that may be stored in the database 104. The user interface 108 may also be configured to allow the user to interact with the digital content that is retrieved from the database and subsequently stored on the UE 106 itself, or centrally stored for interaction in the central network 102. The interactions allowing the user experience audio and video multimedia that is stored at the database 104.

In an example, a user can interact with user interface 108 of a UE 106, hosted via a webpage or mobile application, in order to compare a plurality of guitars. The user can make a first guitar selection by selecting a guitar make or series and a model of the guitar. At least two other guitar selections, including a second and third guitar, can be similarly made. Each of the selections made in the prompt via user input can be stored by sending the user's selections to a memory or database 104. Each of these selections can trigger a transmission of the user selections via a central network 102 to the content delivery system 110 to collect multimedia streams associated with the guitars selected.

The UE 106 can communicate with the content delivery system 110 through the central network 102 to request digital content associated with the guitar selections. Accordingly, the content delivery system 110, in continuous communication with the database 104, can query the database 104 for digital content that matches the request received from the UE 106, related to the guitar selections. The content delivery system 110 includes at least one processor and at least one memory having computer-executable instructions executed by the processor. The computer-executable instructions can make up one or more services responsible for controlling the retrieval and transmission of the digital content requested that is associated with user request.

The content delivery system 110 can include a control service 112 configured to control the content that is interacted with at the UE 106 and the user interface 108. The control service 112 receives interaction data from the user interface 108, as well as communicates with other services of the content delivery system 110 to effectuate operations of the CDN 100.

In an example, the control service can be responsible for controlling the content that is interacted with by the user at the UE 106. The control service can receive input data from the user interface 108 and communicates that data to other services of the CDN 100, including a communication service 114, which controls the streaming of multimedia content over the central network 102. Within the control service, an interactive engine can process received data and interact with the communication service 114 to adjust the delivery of multimedia content in accordance with user interaction detected at the user interface 108. As the user interaction, including the guitar selections, is received by the content delivery system 110, the control engine can process the received data, representing the selections, to modify parameters associated with the streamed multimedia content, such as playback speed, volume, starting time, ending time, and correlations associated with the multimedia content associated with each user selection. As the control service finalizes the modified parameters, multimedia content associated with the user selections is communicated to the communication service 114, for transmission.

The communication service 114 can include both software and hardware elements for transmitting and receiving signals from/to the content delivery system 110 through the central network 102. The communication service 114 is configured to transmit information wirelessly over the central network 102, for example, through an antenna array that provides personal cellular (long-term evolution (LTE), 3G, 5G, etc.) communication, or a wired or wireless local area network (LAN). As the control service 112 identifies the multimedia content to be streamed to the UE 106, the communication service 114 can process the streams for transmission to the UE 106, to be retained locally or remotely via the content delivery system 110.

In some embodiments, one or more services of the content delivery system 110 are configured to send and receive communications to and from the UE 106 for such reasons as reporting user interface 108 interaction data taking place at the UE 106, and content delivery requests for digital content stored at the database 104.

The content delivery system 110 can also include an instruction service 116 for sending instructions regarding the transmission of digital content to the UE 106, to be displayed via the user interface 108. For example, in response to an output of the communication service 114 or user interface service 122, instruction service 116 can prepare instructions for the database to return a set of multimedia content associated with the interaction data and content delivery requests submitted via user input at the UE 106.

In an example, the control service can communicate with the instruction service 116 to prepare instructions to transmit the multimedia content associated with the user's selections. Further, as the user changes their selections the control service can communicate with the instruction service 116 further to update the multimedia stream that is active, or inactive through the communication service.

In some examples, users oftentimes will desire to compare the plurality of instruments with each other instantaneously while attempting to notice auditory differences in the sounds, pitch, and strumming of the guitar by a guitar player in the video. This instantaneous switching can transmit additional user inputs to the control service 112 for processing, prompting the control service to trigger the instruction service to instruct the communication service to switch the guitar, or the playing style of the plurality of guitars, in real-time, upon the user's selection via the user interface 108.

Accordingly, the user interface service 118 is configured to present sets of multimedia content as instructed by the instruction service 116, relevant to the multimedia stream prepared for streaming by the communication service. Further, the user interface service 118 can prepare the set of multimedia content returned from the database 104, in response to the data interaction or content delivery request, for display at the user interface 108.

The data that is presented in the user interface service 118, can be depicted in an instrument comparison module that permits the user to interact with a set of instruments being compared. The comparison module can allow the user, via the user interface 108, to compare the sounds and style of each of the instruments based on a playing time or an instrumentation type, via a synchronized presentation of multimedia on one display of the UE 106. The comparison can occur in real-time, simultaneous with the user's selection at the user interface 108.

In some examples, the guitar comparison tool, described herein, can be embedded in an e-commerce page for one or more third-party web-based applications, software platforms, or web pages with full functionality of the locally hosted guitar comparison tool involves integrating the tool into a popular music forum website. On this third-party platform, the user interface of the guitar comparison tool can be fully customizable to match the forum's aesthetic and user experience. When users engage with the embedded tool, it communicates with the content delivery system 110 via the network 102 to fetch the necessary data and multimedia content based on user interactions with the interface 108. This seamless integration allows forum members to compare guitars based on their personalized specifications, such as brand, model, and features, directly within the forum environment. The content delivery system 110 can track user interactions to provide analytics on behavior, which can assist one or more providers of the content delivery system the ability to develop a plurality of predictions, and a set of analyses based on an understanding of user preferences to improve further musical instrument offerings. The embedded tool retains the user's guitar selections for verification and outputs relevant multimedia, including audio samples and video demonstrations, to enhance the comparison experience. Accordingly, embedded guitar comparison tool functionality is contained within an iframe or similar container on the forum's website, ensuring smooth operation and user engagement without redirecting users away from the forum.

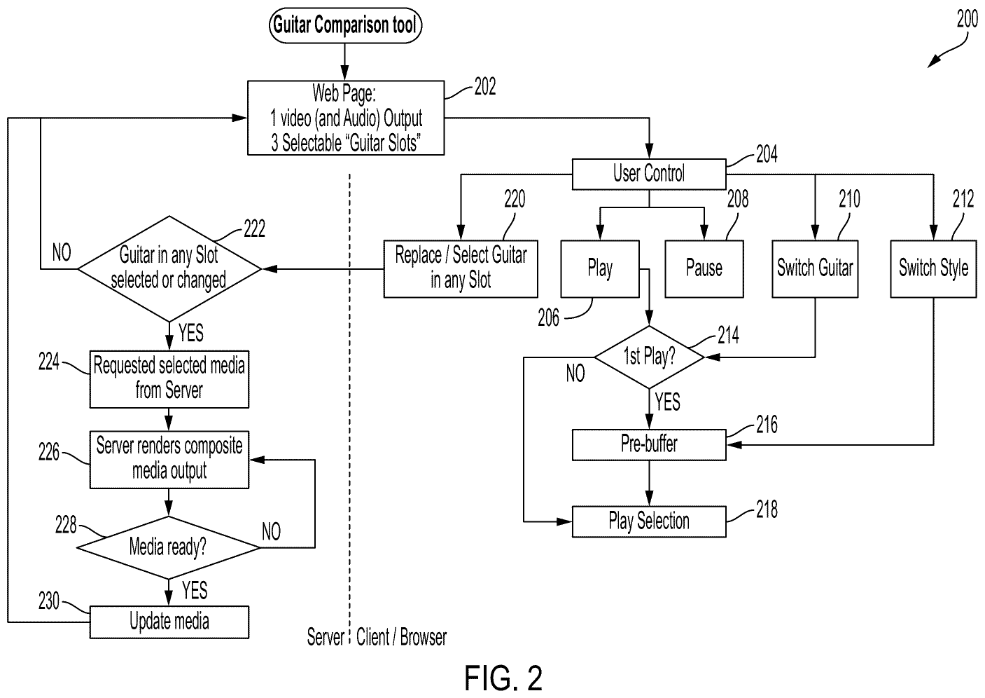

Further discussion is provided below, with reference to FIG. 2, describing an example of comparing a plurality of guitars based on user interaction with the user interface 108. FIG. 2 further discusses a method of digital content retrieval from the database 104 as facilitated by the content delivery system 110.

FIG. 2 illustrates an example process for guitar comparison, according to aspects of the disclosure. Although the example process 200 depicts a particular sequence of operations, the sequence may be altered without departing from the scope of the present disclosure. For example, some of the operations implemented by a client device and the server independently depicted, may be performed in parallel or in a different sequence that does not materially affect the function of the process 200. In other examples, different components of an example device or system that implements the process 200 may perform functions at substantially the same time or in a specific sequence.

Upon accessing the guitar comparison tool a user can interact via web page 202 the guitar comparison module via a web browser accessible via a UE. The guitar comparison module is configured to provide a user the ability to select one or more instruments, in this example guitars, based on personalized specifications. The selection made by the user can be retained and visible for the user's verification of selection in one or more selection interfaces. Based on the selections, the guitar comparison module is configured to output multimedia including audio and video.

In an example, the user can interact with a web-based platform via a UE in order to input a plurality of selections. The selections made by the user can include a guitar series and a guitar model for at least three guitars of interest for comparison. The user input provided via the user interface 108 of the UE 106, of FIG. 1, can be output to the content delivery system 110, in real-time, simultaneous with the user inputs received, to the control service 112.

The guitar comparison module, upon receiving the user selections, via a controller, is configured to allow the user control 204 to take a plurality of actions to interact with the multimedia related to the guitar selection.

In an example, the user inputs received from the UE 106 of FIG. 1, that are output to the control service 112, can be processed for user control of audio or video associated with the guitar series and guitar models selected by the user. The user can control the playback of audio or video, including timing and choice of instrument for a specified style.

In some examples, via the controller of the guitar comparison module, the user can elect to play 206 the multimedia selection for one or more of the guitar selections. In some examples, the user can make a selection of a first guitar, playing style selected from one or more of fingerstyle, open chord, and strumming

In an example, the user can interact with the user interface 108 of FIG. 1, where a user input can be received to play at least one of the multimedia streams received from the content delivery system 110.

In some examples, via the controller of the guitar comparison module, the user can also elect to pause 208 the multimedia selection for one or more of the guitar selections. In some examples, the user can pause the selection initially made via the guitar comparison module. The multimedia selection related to the guitar selection will pause the multimedia at the time of pausing, allowing the user to make another selection selected from 206, 210, 212, or 220.

In an example, the user can interact with the user interface 108 of FIG. 1, where a user input can be received to pause at least one of the multimedia streams received from the content delivery system 110.

In some examples, the user can make a selection to switch guitars 210 to another guitar selection to another guitar initially selected in the guitar comparison module. In some examples, a user can make a first selection of a guitar, causing the multimedia to play 206, one or more of a fingerstyle, open chord, or strumming playing style. The user can subsequently make another selection of a second guitar, resulting in the playing style briefly pausing during an immediate switch at a time period. A controller of the guitar comparison module can immediately switch from the first guitar to the second guitar selection, resulting in the second guitar selection picking up where the first guitar selection paused at the time period of the switch selection made by the user. Thus, the second guitar selection begins playing the same instrumentation or chords in relation to the playing style.

In an example, the user can interact with the user interface 108 of FIG. 1, where a user input can be received to switch the type of guitar to one of the additional guitar series and models initially selected in a first comparison and subsequent for multimedia associated with the initial selections. The user in some examples, can make a request via a user input at the user interface 108, to switch the guitar series and models of at least one of the guitars being compared to create an additional comparison of the playing style of the guitars selected.

At step 212, the user can further make a selection to switch the playing style between the fingerstyle, open chord, or strumming playing styles. In some examples, a user can initially play one of the playing styles for one or more of the guitar selections. The user can make a selection to cause the guitar comparison module to play a different playing style, for the same instrument. The user can make this selection multiple times causing the guitar comparison module to switch between the playing styles based on the instrument or guitar selected.

In an example, during the playing of one of the guitars being compared, the user can switch the playing style of the guitar currently playing in real-time via the user interface 108 of FIG. 1. The playing style can be switched from fingerstyle, open chord, or strumming playing styles.

At step 214, upon the user making either of the play 206, or switch guitar 210, selections the guitar comparison module can determine if the multimedia is being played for the first time. If the multimedia is being played for the first time, the guitar comparison module can initially pre-buffer 216 the multimedia selection and then play the selection 218. In the instance where the multimedia is not being played for the first time, the multimedia selection can be played immediately upon a selection being made by the user. In instances where the playing style is being switched during the stream or playing of the guitar multimedia, a pre-buffer 216 process can take place, followed by a playing of the selection 218.

At step 220, the user may elect to replace or select a different guitar to place into one or more of the selection slots in the guitar comparison module. Upon the user selecting a different guitar, the client device can communicate the user's selection to a server to process the request associated with the selection.

At step 222, the server can receive the request from the client device to identify if a guitar in the selection pane has been selected or changed. Upon determining that there is a guitar selection change detected, the user-requested media can be collected from the server, as shown in step 224.

At step 226, the server can render the composite media output associated with the detected user selection for processing prior to transmission back to the client device.

At step 228, upon determining the media is ready for transmission, the media selections are updated, at step 230, and transmitted to the guitar comparison module to be output via the web browser of the client device at step 202. Alternatively, in step 228, if the media is determined not to be ready for transmission by the server, the server renders the composite media output until the media is ready for transmission.

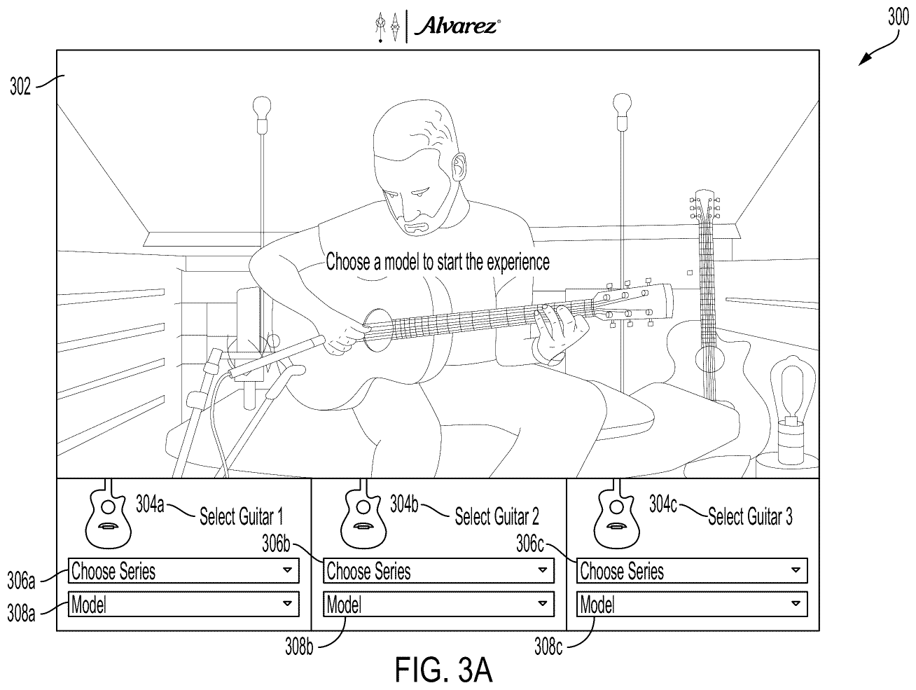

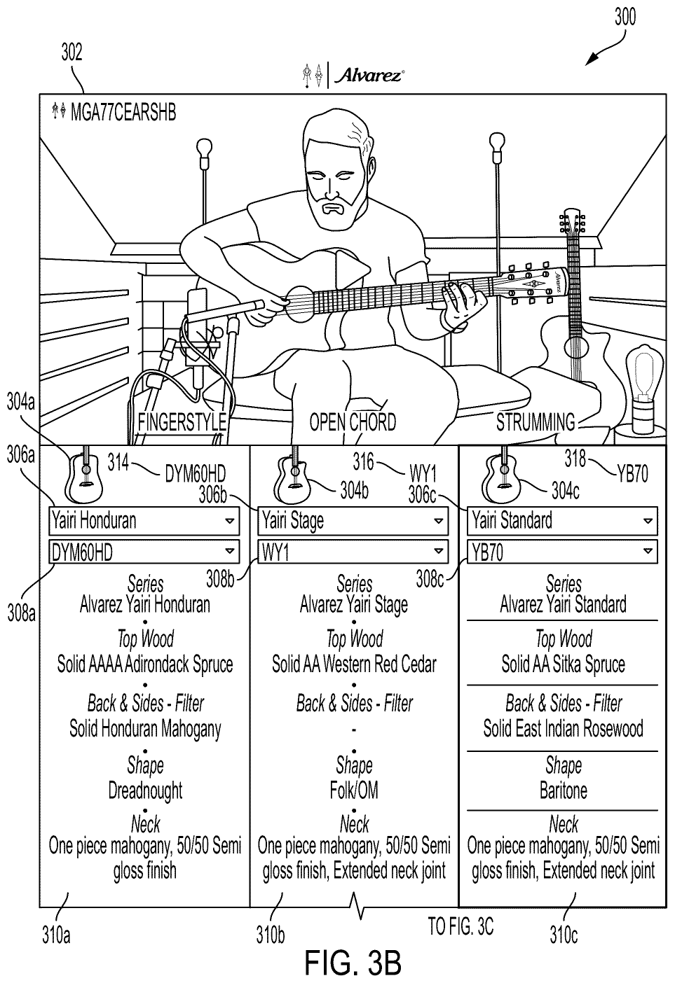

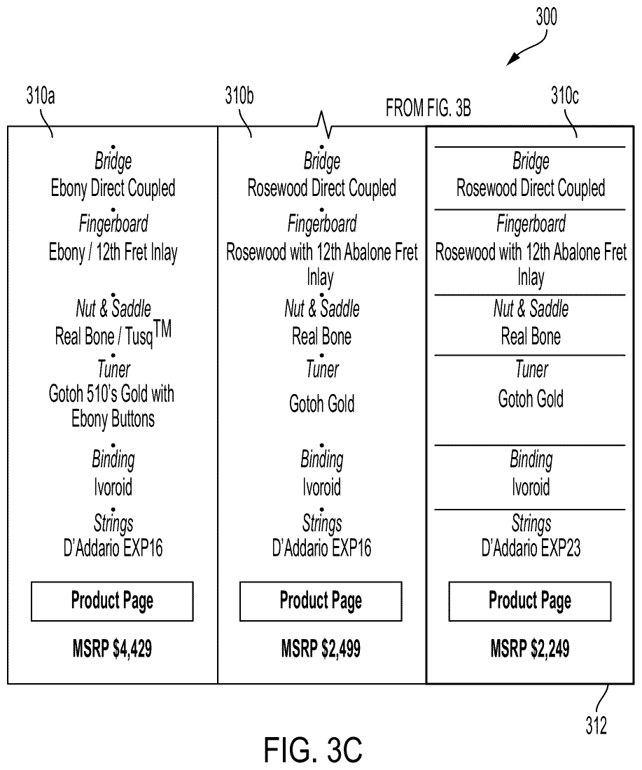

FIG. 3A illustrates a selection module 300 in a user interface of the UE, according to aspects of the disclosure, as it relates to FIG. 2 discussed above. The selection module 300 includes a display 302, and a plurality of guitar selections including a first guitar selection 304a, a second guitar series 306b, and a third guitar selection 304c. Associated with each of the guitar selections 304a-c is a first guitar model 308a and a first guitar series 306a, a second guitar model 308b and second guitar series 306b, and a third guitar model 308c and a third guitar series 306c.

In an example, a user can interact with the selection module 300 in a user interface 108 via a UE or client device, as discussed above with reference to FIG. 1. The user can make a first guitar selection 304a by selecting the first guitar series 306a from a plurality of guitar selections, and the first guitar model 308a, from a plurality of model selections associated with the first guitar series 306a. The user can subsequently make a second guitar selection 304b by selected a second guitar series 306b, and a second guitar model 308b. The user can further make a third guitar selection 304c by selecting a third guitar series 306c, and a third guitar model 308c of the third guitar series 306c. As the user makes a first guitar selection 304a, a second guitar selection 304b, and a third guitar selection 304c, based on the selected respective guitar series 306a-c, and guitar models 308a-c, the selection module 300 can populate details pertaining to each of the guitar selections 304a-c.

Each of the guitar selections 304a-c are associated with a multimedia selection that can be displayed via the display 302 of the UE 106. As interacts with the selection module 300 and selects one of the guitar selections 304a-c selected to interact with, in a first instance, the display can provide multimedia including audio and video for the selected guitar in the display for comparison with the other selections, upon making a different selection, in a second instance.

In an example, upon the population of the details pertaining to each of the guitar selections 304a-c, and the associated multimedia being received from the content delivery system 110 of FIG. 1, the display 302 can present the three different guitar selections 304a-c in a user interface 108 of the UE 106. Upon being presented with the guitar selections 304a-c, the user may begin to compare each of the guitar series 306a-c and guitar models 308a-c, based on their playing style, as displayed by the multimedia, including audio and/or video of the guitars selected. The user may interact with the multimedia of each of the guitars to play, pause, switch the guitar to another one of the guitars being compared in the display 302. The comparison of the guitar selections 304a-c by the user can be based on the audio output through the UE 106, or the video viewable via the display 302 of FIG. 3A.

FIG. 3B-3C illustrates a guitar comparison in the selection module 300 in the user interface of the UE, according to aspects of the disclosure, as it relates to FIG. 3A. Upon the user making the first guitar selection 304a in the selection module 300, a first guitar product information 310a corresponding with the first guitar model 308a and first guitar series 306a of the first guitar selection 304a can be populated. Upon the user making the second guitar selection 304b, a second guitar product information 310b corresponding with the second guitar model 308b and second guitar series 306b can be populated. Upon the user making the third guitar selection 304c, a second guitar product information 310b corresponding with the third guitar model 308c and third guitar series 306c can be populated.

As the first guitar product information 310a, second guitar product information 310b, and third guitar product information 310c is populated, the user can compare product information for each of the guitar selections 304a-c in order to determine if the product specifications meet the user's personal preferences. The user can then make a current selection 312, that will subsequently load the multimedia associated with the guitar selected in the display 302 to be played and interacted with.

In an example, the user can update their selection by making updates to either the guitar series 306a-c, or the guitar models 308a-c. Upon an update being made, the selection module 300 can dynamically make updates to the guitar product information 310a-c associated with each of the guitar selections 304a-c.

In an example, the user can further make a playing style selection within the selection module 300, in order to hear one or more of a fingerstyle playing style 314, an open chord playing style 316, or a strumming playing style 318. Upon receiving a playing style selection, the selection module 300 can change the multimedia associated with the playing style, in the display 302 for interaction by the user via the user interface.

For example, during the comparison by the consumer, the consumer can switch between the three different styles of playing, amongst the three different types of instruments, to hear the comparison while playing the same exact chord/notes of the song. When the play style is switched, the play style is also switched for each of the three instruments. Specifically, during the stitching, the server configures the three videos to all run simultaneously to maintain the synchronization in preparation for the consumer's switch input from the tool. The switch input activates a single stream to be played while the others play in the background coordinated or in sync with the currently playing stream associated with the specific instrumentation.

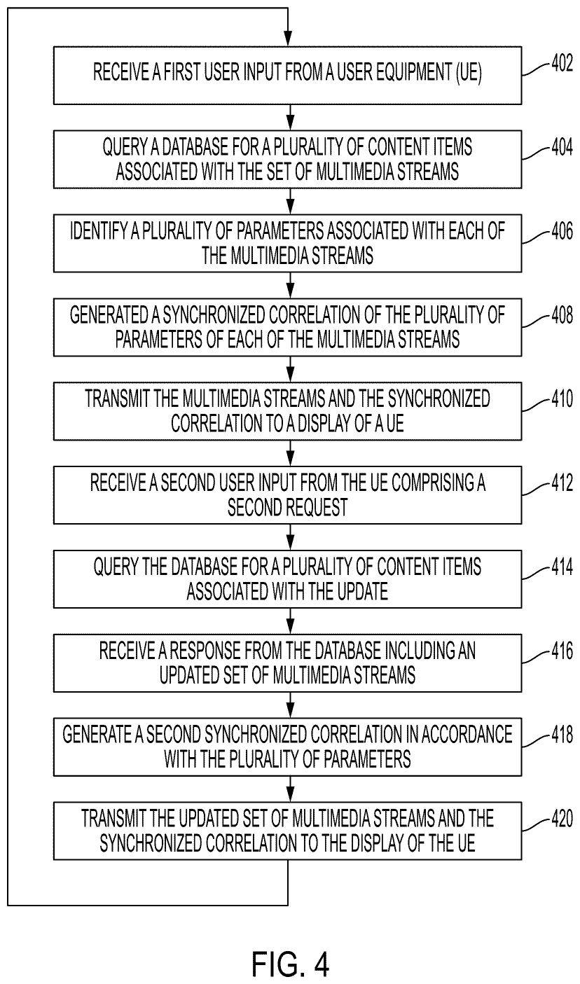

FIG. 4 illustrates an example process of comparing a plurality of guitars in the comparison module, according to aspects of the disclosure. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

At step 402, the method includes receiving a first user input from a user equipment (UE). For example, the content delivery system 110 illustrated in FIG. 1 may receive a first user input from a user equipment (UE). The first user input comprising a request to retrieve digital content comprising a set of multimedia streams.

Further, the method comprises selecting at least three instrument types. For example, user input can be received by the selection module 300 illustrated in FIG. 3A, where the user may select at least three instrument types. Each instrument type is configured to be compared within the display 302 of the UE 106 of FIG. 1.

Further, the method comprises selecting at least three playing styles. For example, the user upon interacting with user interface 108 illustrated in FIG. 1, may select at least three playing styles. Each playing style is configured to be compared within the display of the UE, via the audio heard via the UE 106, or the video viewed via the user interface 108 or display 302 of FIG. 3A.

At step 404, the method includes querying a database for a plurality of content items associated with the set of multimedia streams. For example, the content delivery system 110 illustrated in FIG. 1 may query a database 104 for a plurality of content items associated with the set of multimedia streams. Each of the multimedia streams can comprise of audio and video of guitar selections 304a-c of FIG. 3A made in the selection module 300.

Further, the method comprises receiving from the database 104 at least three sound types for each multimedia stream. For example, the content delivery system 110 illustrated in FIG. 1 can receive from the database 104 at least three sound types for each multimedia stream selected from the strumming playing style 318, open chord playing style 316, and the fingerstyle playing style 314 of FIG. 3B.

Further, the method comprises identifying additional time codes for each of the sound types based on the synchronized correlation. For example, the content delivery system 110 illustrated in FIG. 1 may identify additional time codes for each of the sound types based on the synchronized correlation.

At step 406, the method includes identifying a plurality of parameters associated with each of the multimedia streams. For example, the content delivery system 110 illustrated in FIG. 1 may identify a plurality of parameters associated with each of the multimedia streams. The plurality of parameters includes a length of the multimedia streams.

At step 408, the method includes generating a synchronized correlation of the plurality of parameters of each of the multimedia streams. For example, the content delivery system 110 illustrated in FIG. 1 may generate a synchronized correlation of the plurality of parameters of each of the multimedia streams. Each of the multimedia streams is correlated with a same time code for reference by the UE 106, when receiving user input via the user interface 108 from the user, to switch from one of the guitar selections 304a-c of FIG. 3A, to another.

At step 410, the method includes transmitting the multimedia streams and the synchronized correlation to a display of a UE. For example, the content delivery system 110 illustrated in FIG. 1 may transmit the multimedia streams and the synchronized correlation to a display of a UE 106. The time code is maintained based on the playing position of at least one of the multimedia streams. The display of the UE 106 is configured to permit the user to dynamically switch between each of the multimedia streams associated with at least one sound type. The display is configured to permit the user to interact with the plurality of content in accordance with the same time code.

Further, the method comprises continuously updating the time code for each of the multimedia streams based on a playing position of at least one of the multimedia streams. For example, the content delivery system 110 illustrated in FIG. 1 may receive from the UE 106 a play and pause position for each of the multimedia streams, based on a user interaction, and update the time code based on the user interaction via the user interface 108.

Further, the method comprises interacting with at least one of the multimedia streams. Accordingly, the interacting initiated by the user via the UE 106 can cause the system to initiate an update of the time code, based on a playing position of the one or more multimedia streams.

Further, the method comprises synchronously updating the time code for each additional multimedia stream in the set of multimedia streams based on the update of the time code. For example, the content delivery system 110 illustrated in FIG. 1 may update the time code of the additional multimedia streams in the selection module 300 for FIG. 3A based on the user interaction at the user interface 108 causing the multimedia to be paused or played at various time intervals.

At step 412, the method includes receiving a second user input from the user equipment comprising a second request. For example, the content delivery system 110 illustrated in FIG. 1 may receive a second user input via the user interface 108 from the UE 106 comprising a second request. The second request to retrieve digital content includes transmitting a request for an update to at least one of the multimedia streams to the content delivery system 110.

At step 414, the method includes querying the database for a plurality of content items associated with the update. For example, the content delivery system 110 illustrated in FIG. 1 may query the database 104 for a plurality of content items associated with the update.

At step 416, the method includes receiving a response from the database, including an updated set of multimedia streams. For example, the content delivery system 110 illustrated in FIG. 1 may receive a response from the database 104, including an updated set of multimedia streams.

At step 418, the method includes generating a second synchronized correlation in accordance with the plurality of parameters. For example, the content delivery system 110 illustrated in FIG. 1 may generate a second synchronized correlation in accordance with the plurality of parameters. Each of the multimedia streams in the second set of multimedia streams is correlated with the same time code.

At step 420, the method includes transmitting the updated set of multimedia streams and the synchronized correlation to the display of the UE. For example, the content delivery system 110 illustrated in FIG. 1 may transmit the updated set of multimedia streams and the synchronized correlation to the display of the UE 106.

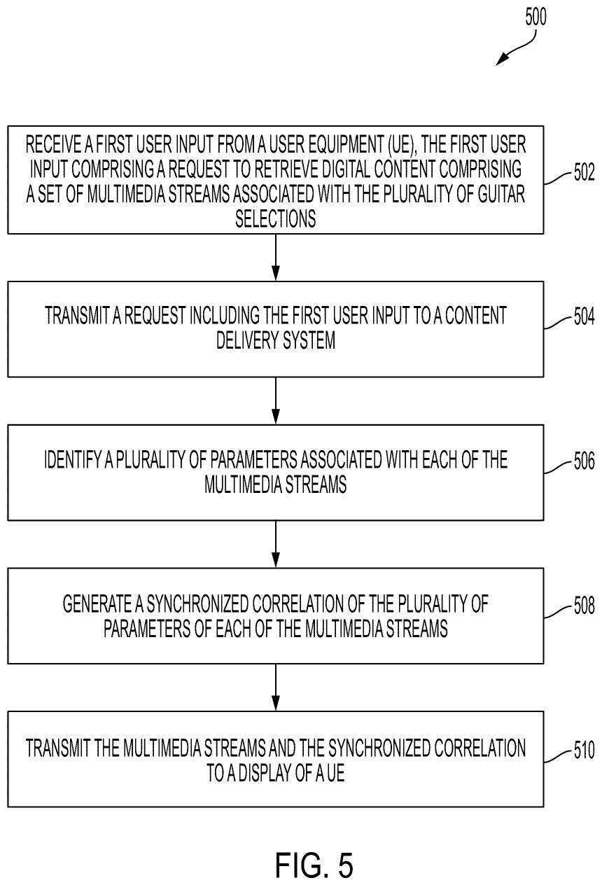

FIG. 5 illustrates an example process of comparing digital content of a plurality of guitar selections, according to aspects of the disclosure. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

At step 502, the method includes receiving a first user input from a UE, the first user input comprising a request to retrieve digital content comprising a set of multimedia streams associated with the plurality of guitar selections. The first user input can include a first guitar selection comprising a first guitar series and a first guitar model. The first user input can include a second guitar selection comprising a second guitar series and a second guitar model.

The first user input can include a third guitar selection comprising a third guitar series and a third guitar model.

For example, the selection module 300 of FIG. 3A can receive a first guitar selection 304a, a second guitar selection 304b, and a third guitar selection 304c, each including guitar series 306a-c, and guitar models 308a-c, from the user's input into the user interface 108 of FIG. 1.

In step 504, the method includes transmitting a request, including the first user input to a content delivery system. The content delivery system can be configured to query a database for a plurality of content items, including the set of multimedia streams of the first, second, and third guitar selections.

For example, the UE 106 of FIG. 1, can transmit the user's input to the content delivery system 110. The content delivery system 110 can query the database 104 for the user input, via a request to identify multimedia content related to the user's input.

In step 506, the method includes identifying a plurality of parameters associated with each of the multimedia streams. For example, the content delivery system 110 of FIG. 1, can process the multimedia streams received from the database 104, and prepare the streams to be transmitted to the UE 106 by identifying a plurality of parameters of each of the multimedia streams.

In step 508, the method includes generating a synchronized correlation of the plurality of parameters of each of the multimedia streams. Each of the multimedia streams can be correlated with a same time code. For example, the control service 112 of FIG. 1, can identify based on the plurality of parameters, synchronization elements, including the time code of each of the multimedia streams of the guitar selections 304a-c of FIG. 3A. These synchronization elements can allow the control service to communicate a synchronized correlation as a multimedia output that includes the multimedia streams for each of the guitar series 306a-c, to the communication service 114 for transmission.

In step 510, the method includes transmitting the multimedia streams and the synchronized correlation to a display of a UE, wherein the display is configured to permit the user to interact with the plurality of content in accordance with the same time code.

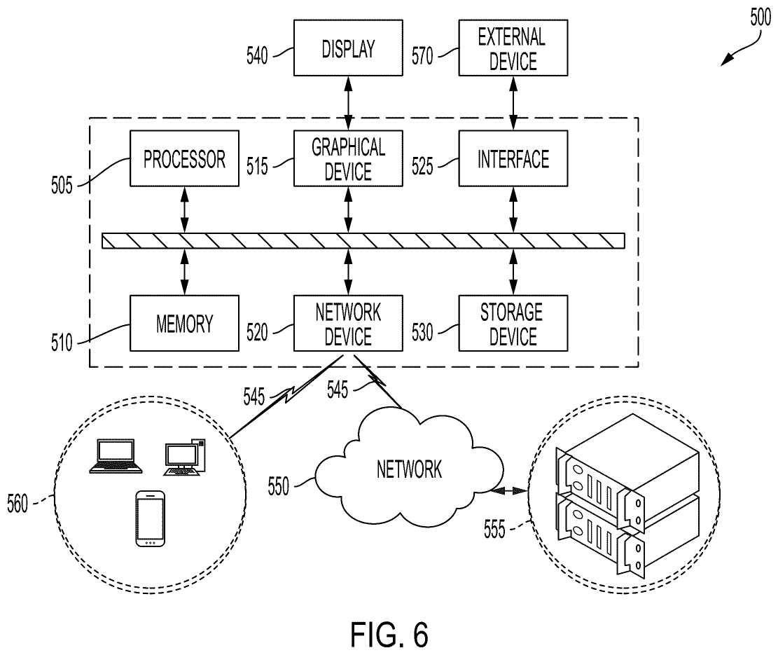

FIG. 6 illustrates an example computer system 600 for implementing a part of the instant disclosure. For example, the example computer system 600 may execute a client application for performing the instant disclosure.

The example computer system 600 includes a processor 605, a memory 610, a graphical device 615, a network device 620, interface 625, and a storage device 630 that are connected to operate via a bus 635. The processor 605 reads causes machine instructions (e.g., reduced instruction set (RISC), complex instruction set (CISC), etc.) that are loaded into the memory 610 via a bootstrapping process and executes an operating system (OS) for executing applications within frameworks provided by the OS. For example, processor 605 may execute an application that executes an application provided by a graphical framework such as Winforms, Windows Presentation Foundation (WPF), Windows User Interface (WinUI), or a cross-platform user interface such as Xamarin or QT. In other examples, the processor 605 may execute an application that is written for a sandbox environment such as a web browser.

Processor 605 controls memory 610 to store instructions, user data, OS content, and other content that cannot be stored within processor 605 internally (e.g., within the various caches). The processor 605 may also control a graphical device 615 (e.g., a graphical processor) that outputs graphical content to a display 640. In some examples, the graphical device 615 may be integral within the processor 605. In yet another example, the display 640 may be integral with the computer system 600 (e.g., a laptop, a tablet, a phone, etc.).

The graphical device 615 may be optimized to perform floating point operations such as graphical computations and may be configured to execute other operations in place of the processor 605. For example, controlled by instructions to perform mathematical operations optimized for floating point math. For example, the processor 605 may allocate instructions to the graphical device 615 for operations that are optimized for the graphical device 615. For instance, the graphical device 615 may execute operations related to artificial intelligence (AI), natural language processing (NLP), vector math. The results may be returned to the processor 605. In another example, the application executing in the processor 605 may provide instructions to cause the processor 605 to request the graphical device 615 to perform the operations. In other examples, the graphical device 615 may return the processing results to another computer system (i.e., distributed computing).

The processor 605 may also control a network device 620 for transmitting and receiving data using a plurality of wireless channels 645 and at least one communication standard (e.g., Wi-Fi (i.e., 802.11ax, 802.11e, etc), Bluetooth®, various standards provided by the 3rd Generation Partnership Project (e.g., 3G, 4G, 5G), or a satellite communication network (e.g., Starlink). The network device 620 may wirelessly connect to a network 650 to connect to servers 655 or other service providers. The network device 620 may also be connected to the network 650 via a physical (i.e., circuit) connection. The network device 620 may also directly connect to local electronic device 660 using a point-to-point (P2P) or a short-range radio connection.

The processor 605 may also control an interface 625 that connects with an external device 670 for bidirectional or unidirectional communication. Interface 625 is any suitable interface that forms a circuit connection and can be implemented by any suitable interface (e.g., universal serial bus (USB), Thunderbolt, and so forth). The external device 665 is able to receive data from interface 625 to process the data or perform functions for different applications executing in processor 605. For example, the external device 665 may be another display device, a musical instrument, a computer interface device (e.g., a keyboard, a mouse, etc.), an audio device (e.g., an analog-to-digital converter (ADC), a digital-to-analog converter (DAC)), a storage device for storing content, an authentication device, an external network interface (e.g., a 5G hotspot), a printer, and so forth.

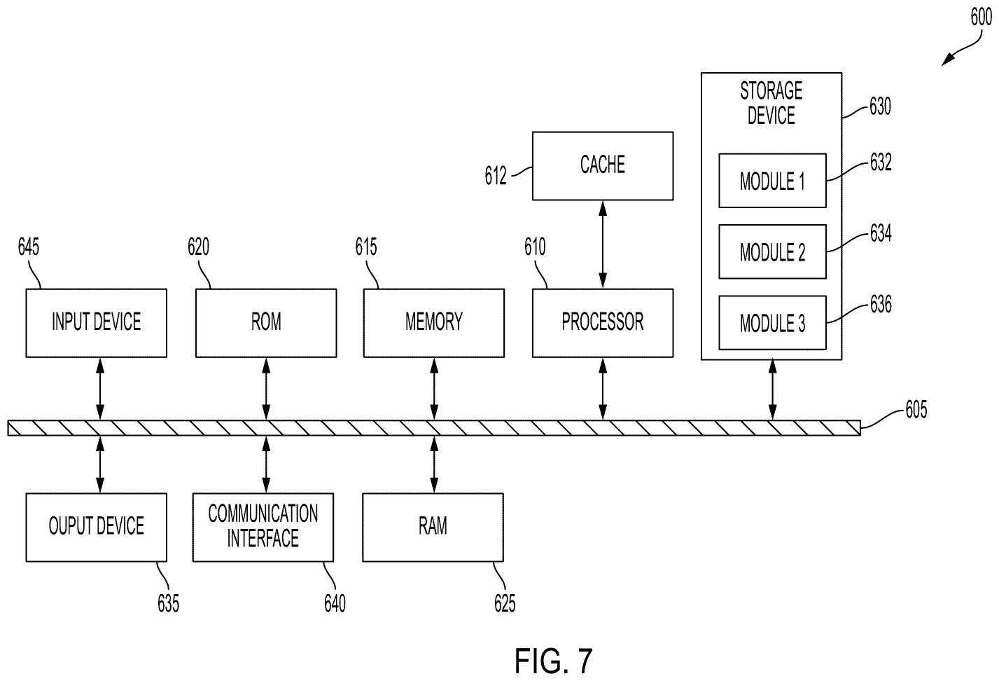

FIG. 7 shows an example of computing system 700, which can be, for example, any computing device making up the UE 106, the database 104, the content delivery system 110, or any component thereof in which the components of the system are in communication with each other using connection 705. Connection 705 can be a physical connection via a bus or a direct connection to processor 710, such as in a chipset architecture. Connection 705 can also be a virtual connection, networked connection, or logical connection.

In some embodiments, computing system 700 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

In some examples, computing system 700 includes at least one processing unit (CPU or processor) 710 and connection 705 that couples various system components, including system memory 715, such as read-only memory (ROM) 720 and random-access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore, the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for providing digital content, the method comprising:
receiving a first user input from a user equipment (UE), the first user input comprising a request to retrieve digital content comprising a set of multimedia streams;
in response to receiving the first user input, querying a database for a plurality of content items associated with the set of multimedia streams;
identifying a plurality of parameters associated with each of the multimedia streams;
generating a synchronized correlation of the plurality of parameters of each of the multimedia streams, wherein each of the multimedia streams are correlated with a same time code; and
transmitting the multimedia streams and the synchronized correlation to a display of a UE, wherein the display is configured to permit the user to interact with the plurality of content in accordance with the same time code.

2. The method of claim 1, further comprising:
continuously updating the time code for each of the multimedia streams based on a playing position of at least one of the multimedia streams.

3. The method of claim 1, wherein each of the multimedia streams comprises of audio and video.

4. The method of claim 1, further comprising:
receiving from the database at least three sound types for each multimedia stream; and
identifying additional time codes for each of the sound types based on the synchronized correlation.

5. The method of claim 1, wherein the display of the UE is configured to permit the user to dynamically switch between each of the multimedia streams associated with at least one sound type, and the time code is maintained based on a playing position of at least one of the multimedia streams.

6. The method of claim 1, further comprising:
interacting with at least one of the multimedia streams, wherein the interacting causes an update of the time code; and
synchronously updating the time code for each additional multimedia stream in the set of multimedia streams based on the update of the time code.

7. The method of claim 1, wherein the user input comprises:
selecting at least three instrument types, wherein each instrument type is configured to be compared within the display of the UE; or
selecting at least three playing styles, wherein each playing style is configured to be compared within the display of the UE.

8. The method of claim 1, further comprising:
receiving a second user input from the user equipment comprising a second request, wherein the second request to retrieve digital content including an update to at least one of the multimedia streams;
in response to receiving the second user input, querying the database for a plurality of content items associated with the update; and
receiving a response from the database including an updated set of multimedia streams.

9. The method of claim 8, further comprising:
generating a second synchronized correlation in accordance with the plurality of parameters, wherein each of the multimedia streams in the second set of multimedia streams are correlated with the same time code; and
transmitting the updated set of multimedia streams and the synchronized correlation to the display of the UE.

10. The method of claim 1, wherein the plurality of parameters includes a length of the multimedia streams, a multimedia type, and a size of the multimedia streams.

11. A system for providing digital content, comprising:
a storage configured to store instructions;
a processor configured to execute the instructions and cause the processor to:
receive a first user input from a user equipment (UE), the first user input comprising a request to retrieve digital content comprising a set of multimedia streams;
in response to receiving the first user input, query a database for a plurality of content items associated with the set of multimedia streams;
identify a plurality of parameters associated with each of the multimedia streams;
generate a synchronized correlation of the plurality of parameters of each of the multimedia streams, wherein each of the multimedia streams are correlated with a same time code; and
transmit the multimedia streams and the synchronized correlation to a display of a UE, wherein the display is configured to permit the user to interact with the plurality of content in accordance with the same time code.

12. The system of claim 11, wherein the processor is configured to execute the instructions and cause the processor to:
continuously updating the time code for each of the multimedia streams based on a playing position of at least one of the multimedia streams.

13. The system of claim 11, wherein each of the multimedia streams comprises of audio and video.

14. The system of claim 11, wherein the processor is configured to execute the instructions and cause the processor to:
receive from the database at least three sound types for each multimedia stream; and
identify additional time codes for each of the sound types based on the synchronized correlation.

15. The system of claim 11, wherein the display of the UE is configured to permit the user to dynamically switch between each of the multimedia streams associated with at least one sound type, and the time code is maintained based on a playing position of at least one of the multimedia streams.

16. The system of claim 11, wherein the processor is configured to execute the instructions and cause the processor to:
interact with at least one of the multimedia streams, wherein the interacting causes an update of the time code; and
synchronously update the time code for each additional multimedia stream in the set of multimedia streams based on the update of the time code.

17. The system of claim 11, wherein the processor is configured to execute the instructions and cause the processor to:
select at least three instrument types, wherein each instrument type is configured to be compared within the display of the UE; or
select at least three playing styles, wherein each playing style is configured to be compared within the display of the UE.

18. The system of claim 11, wherein the processor is configured to execute the instructions and cause the processor to:
receive a second user input from the user equipment comprising a second request, wherein the second request to retrieve digital content including an update to at least one of the multimedia streams;
in response to receiving the second user input, query the database for a plurality of content items associated with the update; and
receive a response from the database including an updated set of multimedia streams.

19. The system of claim 18, wherein the processor is configured to execute the instructions and cause the processor to:
generate a second synchronized correlation in accordance with the plurality of parameters, wherein each of the multimedia streams in the second set of multimedia streams are correlated with the same time code; and
transmit the updated set of multimedia streams and the synchronized correlation to the display of the UE.

20. A method for comparing digital content of a plurality of guitar selections, the method comprising:
receiving a first user input from a user equipment (UE), the first user input comprising a request to retrieve digital content comprising a set of multimedia streams associated with the plurality of guitar selections, wherein the first user input comprises:
a first guitar selection comprising a first guitar series and a first guitar model;
a second guitar selection comprising a second guitar series and a second guitar model; and
a third guitar selection comprising a third guitar series and a third guitar model;
transmitting a request including the first user input to a content delivery system, wherein the content delivery system is configured to query a database for a plurality of content items including the set of multimedia streams of the first, second, and third guitar selections;
identifying a plurality of parameters associated with each of the multimedia streams;
generating a synchronized correlation of the plurality of parameters of each of the multimedia streams, wherein each of the multimedia streams are correlated with a same time code; and
transmitting the multimedia streams and the synchronized correlation to a display of a UE, wherein the display is configured to permit the user to interact with the plurality of content in accordance with the same time code.
